(19) United States
(12) Patent Application Publication
(10) Pub. No.: US 2009/0049078 A1
(43) Pub. Date: Feb. 19, 2009

(54) AUTOFOLDERING PROCESS IN CONTENT MANAGEMENT

(75) Inventors: Edward Joseph Gallagher, San Jose, CA (US); Tawei Hu, San Jose, CA (US); Lily Liang, San Jose, CA (US); Kenneth Carlin Nelson, Hollister, CA (US); Li-Ming A. Wang, Darnestown, MD (US)

Correspondence Address: IBM ST-SVL;SAWYER LAW GROUP LLP, 2465 E. Bayshore Road, Suite No. 406, PALO ALTO, CA, 94303, US

(73) Assignee: INTERNATIONAL BUSINESS MACHINES CORPORATION, Armonk, NY (US)

(21) Appl. No.: 12/202,294

(22) Filed: Aug. 31, 2008

Related U.S. Application Data
(63) Continuation of application No. 10/131,653, filed on Apr. 23, 2002.

(51) Int. Cl. G06F 17/30

(52) U.S. Cl. 707/102; 707/E17.044

(57) ABSTRACT

A system, and program product for managing the creation, retrieval, editing or distribution of content by creating a folder and filing the folder in a library on a selected server. This is accomplished by first creating an autofoldering configuration entry in an Auto Link table. Accomplishment of this step results in returning target item types and an auto folder structure. This auto folder structure contains target and source item type IDs. The next step is fetching a next set of target item type attribute IDs, and looping through item types from the auto folder structure, searching for a target folder for each target item type from the auto folder structure. A link is invoked to a folder for each target item found; and a target folder is created if no target folders are found.

### CROSS-REFERENCE TO RELATED APPLICATIONS

Under 35 U.S.C. § 120 the present application is a continuation of U.S. patent application Ser. No. 10/131,653, filed Apr. 23, 2002, entitled “Autofoldering Process in Content Management,” all of which is incorporated herein by reference.

### FIELD OF THE INVENTION

The invention relates to systems, and program products for organizing and inter-relating data files, including relational database management system models and foldering of content.

### BACKGROUND OF THE INVENTION

As used herein a “folder” is a named collection of related files that can be retrieved, moved, and otherwise manipulated as one entity.

“Foldering” is a process where a content management system manages and/or controls the creation, retrieval, editing and distribution of content within an information processing system. Generally, the content management system enables an end user to create a folder and file it into a library by interacting with a suitable application. Content filed with the folder and content presently existing in the library can be entered into the folder when the folder is filed in the library. In one type of foldering system, each item of library content has a “content-in-folder” data area which contains a list of each folder that contains the content item. When the content is first filed, a foldering application program may transmit an empty “content-in-folder” table-of-contents data area or table with the content to the library. A library server maintains the content-in-folder table-of-contents for each content stored in the library. When the content is entered into a new folder, the library server may place a new folder entry at the end of the “content-in-folder” table-of-contents. More specifically, the end user interacting with the dialogue manager application specifies requester/principal identifiers, a content library identifier, any content objects to be viewed such as the “content-in-folder” table-of-contents, and any known folder nesting if the identified content is a folder.

Content Management is an infrastructure to manage the full spectrum of digital information. Large collections of scanned images, facsimiles, electronic office documents, XML and HTML files, computer output, audio, video, multimedia, and virtual reality content can be stored and accessed through the content management system. The content management system integrates content with line of business, customer service, ERP, digital asset management, distance learning, Web content management or other applications to accelerate benefits across the enterprise.

In one embodiment the content manager product may be visualized as a triangle, its three vertices being the client, a library server and an object server (resource manager). The client is the user's interface which gives the user the capability of storing, searching for, and, marking-up documents (or to use the more general term, objects). The library server is the equivalent of a card catalog which holds information about the objects, including their location. The object server (OS), also referred to herein as the resource manager (RM) is where either the actual object or a pointer to the actual object is stored.

The core Library Server logic (except for system utilities and housekeeping tasks) is packaged as a set of relational data base (RDB) stored procedures (SPs) containing embedded SQL statements. Each stored procedure (SP) is precompiled and runs on a relational database (RDB) server. Thus each Library Server (LS) process is merely a relational database (RDB) server process. The interface to a Library Server is SQL, through which either stored procedures (SPs) can be called or SQL SELECT statements (including cursor support) can be executed. Remote access to Library Server is via a relational database (RDB) client.

The Resource Managers (RMs) may support different/multiple access protocols. The resource manager (RM)—object server (OS) supports the HTTP protocol.

The basic information entities managed by the Library Server are “items.” “Items” as used herein come in two types, simple items and resource items. Resource items can have content associated with them that is stored in one or more Resource Managers. Resource items point to their content via Resource URL-RELATED DATA. One attribute of “items” is their “folder.”

The library server (LS) and object server (OS) (resource manager (RM)) are separate processes, often running on different machines. In operation, clients first contact the library server (LS) to create/update an index for an object, and to determine where the object is to be stored/replaced. The client then sends a request to the object server (OS) to store/replace the object.

In a content management system with foldering, if the end user desires to view content objects from contents within the folder. The requester application program, in response to the data collected by the dialogue manager application, builds a retrieve request and transmits the request to the library server. The library server copies the identified objects for the contents specified by the end user and returns them to the requester application program. The requester application program then transmits the identified objects to the dialog manager application which facilitates the display thereof to the.

Thereafter, the end user, in response to viewing the content-in-folder table-of-contents, can manipulate the contents of the folder either separately or as a group. The content management system.

In prior content management systems, autofoldering had to be explicitly requested by a client application. To request an autofoldering, the client application must have the knowledge of the target folder table either with or without a target folder identifier. Based on the folder type table specified by a client, the library server can link a newly created document to the folder or search for the specified folder, if not found, dynamically create one then link to it. In the previous content management systems the autofoldering was limited to only one source item to one target item at a time.

Thus, a need exists to make the autofoldering process totally transparent to the client application, and to improve the performance of the existing autolinking process.

### SUMMARY OF THE INVENTION

The system, and program product of the invention make the autofoldering process totally transparent to the client application, and to improve the performance of the existing autolinking process. The advantages of this invention are highlighted as follows:
Autofoldering is transparent to the client application
Autofoldering removes the complexity of the client application.
Autofoldering minimizes the data transmitted across the network traffic for each network communication.
Autofoldering can create multiple items at one API (Application Programming Interface) call.
Autofoldering allows addition of multiple documents to multiple folders.
Autofoldering reduces the number of network communications for the same set of business functions.
Autofoldering allows filing a document into multiple target folders within the same folder type.
Autofoldering allows filing a document into multiple target folders across multiple folder types.
Autofoldering allows multiple attributes to be mapped between the document and the target folder.
Autofoldering can dynamically link multiple documents to multiple target folders via one API call for the existing target folder items or the newly created ones.

This is accomplished by the system, and program product of our invention, which includes managing the creation, retrieval, editing or distribution of content by creating a folder and filing the folder in a library on a selected server. This is accomplished by first creating an autofoldering configuration entry in an Auto Link table. Accomplishment of this step results in returning target item types and an auto folder structure. This auto folder structure contains target and source item type IDs. The next step is fetching a next set of target item type attribute IDs, and looping through item types from the auto folder structure, searching for a target folder for each target item type from the auto folder structure. A link is invoked to a folder for each target item found; and a target folder is created if no target folders are found.

### BRIEF DESCRIPTION OF THE FIGURES

FIG. 1 is an overview of the three elements of a content management system, the client application, the library server, and the resource manager, and the actions between them in storing and replacing an item.

FIG. 2 is a representation of a high level flow chart of the autofoldering method, system, and product of the invention.

FIG. 3 is a stylized overview of the data model for foldering, including autofoldering.

### DETAILED DESCRIPTION OF THE INVENTION

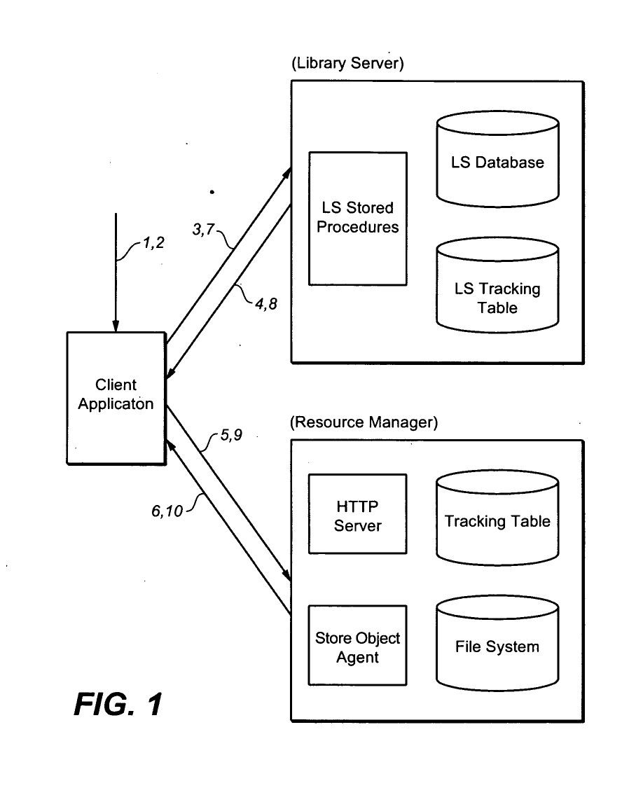

FIG. 1 illustrates the client, the library server, and the resource server, and how they interact to store an item. As shown in the FIGURE, a client application, a library server, and a resource manager are running. The library server includes library server stored procedures, a library server database, and a library server tracking table. The resource manager includes an HTTP server, a Content Management resource manager “Store Object” agent, a resource manager tracking table data base, and a file system.

At a high level, the client begins a transaction, 1, and returns confirmation to the end user, 2. Next, the client establishes a connection to the library server, and sends requests to the library server to create a catalog entry (as an index entry) for a content management object, 3. In response, the client receives information back from the library server as to where to store the object, 4. The client then sends a request to the resource manager to store the object, 5. The client receives a response, 6, from the resource manager with object metadata. This metadata includes, by way of exemplification, the object name, size, and creation timestamp. The client sends this metadata to the library server, 7. The library server replies to the client indicating success or failure of the of the metadata update, 8, at which point the client commits the library server updates, 9. After committing the library server updates, the client requests the resource manager to delete its tracking table record. The client receives a reply from the resource manager indicating success or failure in deleting the tracking table entry, 10.

Within the broader concept of content management, this invention relates to a method of filing a document as a folder in an information processing system for managing a group of documents included in the folder. An end user indicates to the system that a document is to be created as a folder. A number of documents are identified which are to be included in the folder document. A logical relationship is then specified for the identified documents. The identified documents are then filed in the folder having the logical relationship relating to the order in which the documents will be stored therein. Thereafter, the folder is filed in the information processing system.

Within the context of the system shown in FIG. 1, the document management system controls the creation, retrieval, editing and distribution of documents within a content management system. The content management system enables an end user to create a document which includes a plurality of identified documents stored therein. The created document is referred to as a folder. The identified documents are organized in a linear and hierarchical manner. Subsequent operations can be performed on the entire folder. In essence, the folder and all of the documents contained within the folder can be retrieved or printed by referring only to the folder. The end user indicates to the system that a folder is to be created and further indicates the documents to be include therein. Thus, the end user creates the folder and files it into a library. Subsequent operations involving the folder created can be performed on the entire folder without retrieving all of the individual documents stored therein.

The definition of the folder includes an ordering criteria for the documents to be included in the folder, an indication that a document is included in a particular folder, any document-in-folder attributes of the document to be filed including whether or not history is to be maintained on the document and any pointers or addresses of the physical location of all of the documents to be filed in the folder. The physical location includes a document content and any document descriptors for the folder. The documents can be directly accessible to a requester application program or accessible to the requester's library server.

The library server files the folder into a library as specified by the end user. Access control is established and any contextual-search characteristics are enabled as specified. The documents transmitted with the folder request are filed with the appropriate access control and contextual-search characteristics. Data objects associated with the folder document are established to reflect the ordering criteria and the order of any documents currently filed in the folder. The history and open attributes for the folder document may be established and any history attributes for any of the documents filed therein will be established. Thereafter, the data objects associated with the documents contained in the folder document are set to reflect that the document is contained within the folder document being created.

The folder document section may include the following sections: folder attributes and entered document parameters set. The folder attributes indicates the folder characteristics such as ordering criteria and history. Each document entered into the folder document associated with the document relation object will have an entered document parameter set.

To make the autofoldering transparent from the client application, the following process is carried out.

A containment relationship between a document type and a target folder type must be predefined. This predefinition may be via a “SysAdmin” function, such as the ICMdefineAutoFoldering API. This API will turn on the AutoFolderEnable flag in the item type configuration table, ICMSTItemTypeDefs, and store the relationship between the source document type and the target folder type in the Library Server system table ICMSTItemAutoLink for autofoldering. (see, for example, addAutoFolderConfig( ) function implemented in ICMdefineAutoFoldering API)

Whenever a document is created by a client application at run time, if the AutoFolderEnable flag is on, the Library Server will automatically query the autofoldering system table, ICMSTItemAutoLink, to obtain the target folder type information and the attribute ids which are matched between the specified document type and the target folder types. (see, for example, getAutoFolderInfo( ) function).

The Library Server will search the target folder table(s) using the document attribute values provided to determine whether there are any target folders existing. (see, for example, processAutoFoldering( ) which invokes the searchTargetFolder( ) function).

If any target folders are found in the Library Server, then the filing is processed. If none of the target folders exist, then the Library Server will dynamically create a target folder and place the document into the folder. (see, for example, processAutoFoldering( ) which invokes the createTargetFolder( ) and autoFolderLinks( ) for details).

The attribute values needed for creating the target folder are either copied from the attribute values provided for the newly created document (source item) or set to the default value predefined for the specified attribute. The default value can be defined via a system function, such as “SysAdmin” function, ICMdefineCompType API. (see, for example, the ICMSTCompAttrs table definition and insertCompAttrs( )).

To extend the features and capabilities of the dynamic autofoldering requested from the client application, the procedures described below are followed.

The client application is allowed to create multiple items (folders, documents, and resource items) all at once. (see, for example, the API prototype, ICMCreateItem( )).

For each item to be created, the linkOption must be specified. If the client application does not request to explicitly link a document into a folder after the document is created, the pCreateItemStruct->sLinkOption is set to 0. (see, for example, ICMCREATEITEM_STRUCT for details). The library server will create the source item without linking it to any folders unless the AutoFolderEnable flag is set to “on” via the ICMdefineAutoFoldering API. If the AutoFolderEnable flag is set to “on”, then the autofoldering process will be implemented.

If the client application does explicitly request the autofoldering via the ICMCreateItem( ) API call and the pCreateItemStruct->sLinkOption is set to 1, the library server will add the newly created document (or source item) to an existing target folder specified via pCreateItemStruct->pAutoLinkStruct->szParentItemID. (see, for example, ICMAUTOLINK_STRUCT for details).

If the client application does explicitly request the autofoldering via the createItem( ) API call and the pCreateItemStruct->sLinkOption is set to 2, the library server will first create the document (source item) and the target folder, then dynamically link the newly created document (source item) to the newly created target folder after both are successfully created. The target folder is identified by the specified relative sequence number via the pCreateItemStruct->pAutoLinkStruct->sIndexToNewTarget in the API input parameter list (see, for example, ICMAUTOLINK_STRUCT for details).

A link type code must be specified to establish a type of link between two items. The link type code is, typically, a predefined code to indicate whether this link type is a document-to-folder, a folder-to-folder or a resource object-to-document, etc. link. The established link is stored in a link table, such as the ICMSTLinks001001 table to indicate what document is placed in what target folder or what resource items belong to what document. (see, for example, ICMSTLinks001001 table and system-defined LinkTypes and processAutoLink( ) for the implementation details)

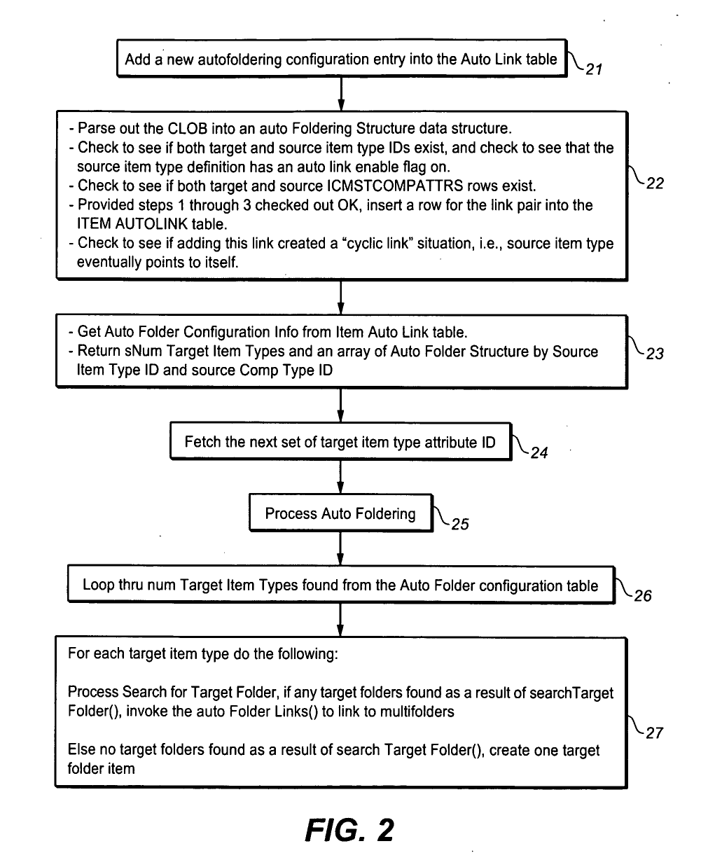

FIG. 2 illustrates a flow chart for the autofoldering process of the invention. The first step is to add a new autofoldering configuration entry into the Auto Link table, 21. Next follow a set of five logic steps, 22, determine what has to be accomplished in a particular case:
1. Parse out the CLOB into an auto Foldering Structure data structure.
2. Check to see if both target and source item type IDs exist, and check to see that the source item type definition has an auto link enable flag on.
3. Check to see if both target and source ICMSTCOMPATTRS rows exist.
4. Provided steps 1 through 3 checked out OK, insert a row for the link pair into the ITEM AUTOLINK table.
5. Check to see if adding this link created a “cyclic link” situation, i.e., source item type eventually points to itself.

If the logic tests are successful, the next step is to Get Auto Folder Configuration Info from Item Auto Link table, which results in a return of sNum Target Item Types and an array of Auto Folder Structure, the array being arrayed by Source Item Type ID and source Comp Type ID, 23. The next step is to fetch the next set of target item type attribute IDs, 24, and process Auto Foldering, 25, as illustrated in the code segment below and in the Appendix:

| extern long processAutoFoldering( | | |
|---|---|---|
| ICMSERVERSTRUCT | | |
| | * pICMServer, | |
| char | * pszSourceItemID, | // in |
| short | * psNumTargetItemTypes, | // in |

| | |
|---|---|
| ICMAUTOFLDR | |
| AutoFldrItemType[ ], | // in |
| ICMITEMSYSATTR_STRUCT | |
| * pItemSystemAttr, | |
| ICMCREATEITEM_STRUCT | |
| * pAutoFldrItem, | // in |

| | |
|---|---|
| long | * plRC, |
| long | * plReason, |
| long | * plExtRC, |
| long | * plExtReason) |
| { | |

```
ICMAUTOFOLDERTARGETS_STRUCT aAutoFldrTargets;
  ICMAUTOFOLDERTARGETS_STRUCT
    *pAutoFldrTargets = &aAutoFldrTargets;
  pAutoFldrTargets->pTargetItemStruct =
  (ICMTARGETITEM_STRUCT*)
    malloc (sizeof (ICMTARGETITEM _STRUCT) *
    ICM_MAX_TARGET_ITEMIDS);
  ICMTARGETITEMID_STRUCT *pTargetItemStruct=
                pAutoFldrTargets->pTargetItemStruct;
  ICMAUTOFLDR *pAutoFldrItemType = aAutoFldrItemType;
```

Auto foldering is accomplished by looping thru num Target Item Types found from the Auto Folder configuration table, 26, and, for each target item type processing a search for Target Folder, 27 (first element), as illustrated in the following code segment:

```
memset (pAutoFldrTargets->szSourceItemID, ‘\0’,
            ICM_ITEMID_LENGTH+1);
strcpy (pAutoFldrTargets->szSourceItemID, pszSourceItemID);
*plRC = searchTargetFolder( // return multi-folders, if exist
        pICMServer,
```

| | |
|---|---|
| pAutoFldrItemType, | // in |
| PAutoFldrTargets, | // out - contains the sNumTargetItemStruct |
| | // if it is > 0, returns an |
| | array of target folders |
| plRC, | |
| plReason, | |
| plExtRC, | |
| plExtReason); | |

If any target folders are found as a result of searchTarget Folder( ), invoking the auto Folder Links( ) to link to multifolders, 27 (second element). This is illustrated in the following code segment (and in the Appendix):

```
  *plRC= autoFolderLinks(  // link to multi-folders, if any
    pICMServer,
    pAutoFldrTargets,
    plRC,
    plReason,
    plExtRC,
    plExtReason);
if (*plRC)
  return (*plRC);
}
```

If, however, no target folders found as a result of search Target Folder( ), one target folder item is created. This also involves creating the appropriate entries, pointers, and indices, as shown, for example, in the code segment below (and in the appendix):

```
char pszDummyCompID[ICM_COMPONENTID_LENGTH+1];
*plRC = createTargetFolder( // create one folder
    pICMServer,
    &pAutoFldrItemType->lTargetItemTypeID, // in
    &pAutoFldrItemType->lTargetCompTypeID, // in
    pAutoFldrItemType,  // in
    pAutoFldrTargets->pTargetItemStruct->szTargetItemID,
    pszDummyCompID,
    pAutoFldrItem,  // in
    pItemSystemAttr,
    plRC,
    plReason,
    plExtRC,
    plExtReason);
if (*plRC)
{
  free (pAutoFldrTargets->pTargetItemStruct);
  pAutoFldrTargets->pTargetItemStruct = NULL;
  return (*plRC);
}
pAutoFldrTargets->sNumTargetItemStruct = 1;
pAutoFldrTargets->pTargetItemStruct->lLinkTypeCode
          = pAutoFldrItemType->lAutoFldrLinkType;
```

The detailed design and implementation of the autofoldering process are illustrated in the Appendix.

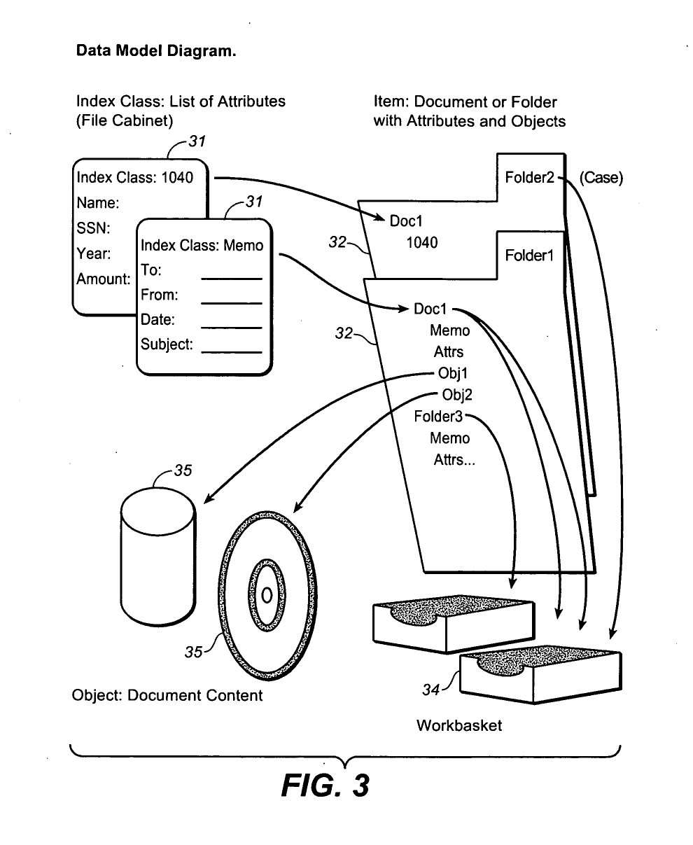

FIG. 3 is a stylized overview of the data model for foldering, including autofoldering. It illustrates an index class, 31, with a list of attributes, documents, 32, document content storage, 35, and a workbasket, 34. Specifically, the index class, 31, contains bibliographic/retrieval information for a folder or a file within the folder. The documents and folders are referenced to associated attributes and objects and to workbaskets, 34.

A program product is computer readable program code on one or more media, said program code being capable of controlling and configuring a computer system having one or more computers. The one or more computers may be configured and controlled to carry out the method described herein. Alternatively, the program may be one or more of encrypted or compressed for subsequent installation, and may be resident on media or on an installation server.

While our invention has been described with respect to certain preferred embodiments and exemplifications, it is not intended to be limited thereby, but solely by the claims appended hereto.

1-5. (canceled)

6. A computer program product tangibly stored on a computer-readable medium and comprising instructions to cause a processor to:
generate a table to store a containment relationship between a source document type ID and a target folder type;
activate a flag indicative of autofoldering;
receive user input, at the client application, specifying that a plurality of documents are to be created, having a plurality of source document type IDs that each identify a type associated with the document;
create the plurality of documents;
if the flag is activated, automatically query a table to obtain a target folder type corresponding to each source document type ID of the plurality of source document IDs associated with the plurality of documents;
determine whether any target folders exist that correspond to each obtained target folder type;
for those target folders that do exist, place corresponding ones of the plurality of documents into one or more existing target folders, in the resource manager, based on the obtained target folder types;
for those target folders that do not exist, dynamically create one or more target folders, in the resource manager, and, without an explicit request from the client application, creating a link corresponding ones of the plurality of documents into one of the one or more dynamically created target folders based on the obtained target folder types, the link including a link type code, wherein one or more of the dynamically created target folders is associated with the plurality of source document type IDs;
store the link in a link table; and
perform a subsequent operation on each of individual documents in a target folder by referring to the target folder without retrieving individual documents stored in the folder.

7. The computer program product of claim 6, wherein the plurality of documents include one or more of documents, folders or resource items.

8. The computer program product of claim 6, wherein one or more of the plurality of documents comprises a scanned image, a facsimile, an electronic office document, an XML file, a HTML file, a computer output, audio content, video content, multimedia content, or virtual reality content.

9. The computer program product of claim 6, further causing the processor to:
receive user input referring only to a first target folder and not to any of a plurality of documents in the first target folder;
receive user input to print the first target folder; and
print each of the plurality of documents in the first target folder.

10. The computer program product of claim 6, wherein the link type is one of a folder-to-folder, a document-to-folder, or a resource object-to-document.
